(19) United States
(12) Patent Application Publication
(10) Pub. No.: US 2015/0091760 A1
(43) Pub. Date: Apr. 2, 2015

(54) ANTENNA BOARD

(71) Applicant: KYOCERA SLC TECHNOLOGIES CORPORATION, Yasu-shi (JP)

(72) Inventor: Yoshinobu SAWA, Moriyama-shi (JP)

(73) Assignee: KYOCERA SLC TECHNOLOGIES CORPORATION, Yasu-shi (JP)

(21) Appl. No.: 14/487,171

(22) Filed: Sep. 16, 2014

(30) Foreign Application Priority Data
Sep. 30, 2013 (JP) 2013-202925
Sep. 30, 2013 (JP) 2013-202926

(51) Int. Cl. H01Q 9/04; H01Q 5/00

(52) U.S. Cl. CPC H01Q 9/0414; H01Q 5/0062
USPC 343/700 MS

(57) ABSTRACT

The antenna board of the present invention includes: a dielectric board 11 in which a plurality of dielectric layers are laminated, a strip conductor 13, a ground conductor layer 12, a first patch conductor 14a, a second patch conductor 14b, and penetration conductors 15 and 16. The first patch conductor 14a and the second patch conductor 14b are electrically independent of each other, at least part of the second patch conductor 14b covers the position where the first patch conductor 14a is formed, and the center of the second patch conductor 14b is deviated in the extending direction of the strip conductor 13 with respect to the center of the first patch conductor 14a.

### BACKGROUND OF THE INVENTION

1. Field of the Invention

The present invention relates to an antenna board which is formed by laminating dielectric layers and conductor layers.

2. Description of Related Art

Conventionally, as indicated by the cross-sectional view and top view shown in FIGS. 11A and 11B, respectively, and the exploded perspective view shown in FIG. 12, for example, an antenna board includes a dielectric board 111 in which a plurality of dielectric layers 111a to 111e are laminated, a ground conductor layer 112 for shielding, a strip conductor 113 for inputting and outputting high-frequency signals, and a patch conductor 114 for transmitting and receiving electromagnetic waves.

The dielectric board 111 is, for example, formed by the five layers of the dielectric layers 111a to 111e being laminated vertically. The dielectric layers 111a to 111e are formed by, for example, a resin layer with glass cloth and a resin without glass cloth. The ground conductor 112 is deposited on the entire bottom surface of the dielectric layer 111a located on the bottom layer. The ground conductor 112 includes, for example, copper. The strip conductor 113 is opposed to the ground conductor 112 across the dielectric layer 111a, and is disposed between the dielectric layers 111a and 111b. The strip conductor 113 is a narrow strip-shaped conductor extending in one direction from the outer peripheral edge to the central part in the inner part of the dielectric board 111, and includes an end part 113a in the central part of the dielectric board 111. The strip conductor 113 includes, for example, copper.

The patch conductor 114 includes a first patch conductor 114a, a second patch conductor 114b, and a third patch conductor 114c. These patch conductors 114a to 114c have quadrangle shapes. The patch conductors 114a to 114c include, for example, copper.

The first patch conductor 114a is disposed between the dielectric layers 111c and 111d so as to cover the position of the end part 113a of the strip conductor 113. The first patch conductor 114a is connected to the end part 113a of the strip conductor 113 via a penetration conductor 115 penetrating the dielectric layer 111c and a penetration conductor 116 penetrating the dielectric layer 111b.

The second patch conductor 114b is disposed between the dielectric layers 111d and 111e so as to cover the position where the first patch conductor 114a is formed. The second patch conductor 114b is electrically independent. The third patch conductor 114c is disposed on the top surface of the dielectric layer 111e so as to cover the position where the second patch conductor 114b is formed. The third patch conductor 114c is electrically independent.

In this antenna board, when a high-frequency signal is supplied to the strip conductor 113, the signal is transmitted to the first patch conductor 114a via the penetration conductors 115 and 116. The signal is radiated as an electromagnetic wave to the outside via the first patch conductor 114a, the second patch conductor 114b and the third patch conductor 114c. By the way, the reason why the antenna board like this includes the electrically independent second patch conductor 114b and third patch conductor 114c as well as the first patch conductor 114a is that the bandwidth of the frequency band of the antenna can be widened by such a configuration. Such a conventional antenna board is described, for example, in Japanese Unexamined Patent Application Publication No. H5-145327.

However, for example, in the wireless personal area network, the frequency band to be used is different in each country, and it is required to cover the wide frequency band of 57 to 66 GHz so that one antenna board is usable in the whole world. To achieve this, an antenna board with a frequency band further wider than the conventional antenna board is required to be provided.

### SUMMARY OF THE INVENTION

It is an object of the present invention to provide a wide band antenna board which is capable of transmitting and receiving a satisfactory signal even in a wide frequency band such as 57 to 66 GHz.

An antenna board of the present invention includes a first dielectric layer, a strip conductor that is disposed on a top surface of the first dielectric layer, extends in one direction from an outer peripheral part of the first dielectric layer, and includes an end part, a ground conductor layer disposed on a bottom surface side of the first dielectric layer, a second dielectric layer laminated on a top surface side of the first dielectric layer and the strip conductor, a first patch conductor disposed on a top surface of the second dielectric layer so as to cover a position of the end part, a third dielectric layer laminated on the second dielectric layer and the first patch conductor, a second patch conductor disposed on a top surface of the third dielectric layer, and a penetration conductor formed to penetrate the second dielectric layer, and to connect the end part and the first patch conductor. The first patch conductor and the second patch conductor have following relations (1) to (3):

(1) the first patch conductor and the second patch conductor are electrically independent,

(2) at least part of the second patch conductor covers a position in which the first patch conductor is formed, and

(3) a center of the second patch conductor is deviated in an extending direction of the strip conductor with respect to a center of the first patch conductor.

Another antenna board of the present invention includes a first dielectric layer, a strip conductor that is disposed on a top surface of the first dielectric layer, extends in one direction from an outer peripheral part of the first dielectric layer, and includes an end part, a ground conductor layer disposed on a bottom surface side of the first dielectric layer, a second dielectric layer laminated on a top surface side of the first dielectric layer and the strip conductor, a first patch conductor disposed on a top surface of the second dielectric layer so as to cover a position of the end part, a third dielectric layer laminated on the second dielectric layer and the first patch conductor, a second patch conductor disposed on a top surface of the third dielectric layer so that at least part of the second patch conductor covers a position in which the first patch conductor is formed, and being electrically independent, and a penetration conductor formed to penetrate the second dielectric layer, and to connect the end part and the first patch conductor. At least one auxiliary patch conductor is disposed on the top surface of the third dielectric layer on each side of the second patch conductor in a direction perpendicular to an extending direction of the strip conductor so as not to cover a position in which the second patch conductor is formed, and the auxiliary patch conductor is electrically independent of the second patch conductor.

Still another antenna board of the present invention includes a first dielectric layer, a strip conductor that is disposed on a top surface of the first dielectric layer, extends in one direction from an outer peripheral part of the first dielectric layer, and includes an end part, a ground conductor layer disposed on a bottom surface side of the first dielectric layer, a second dielectric layer laminated on a top surface side of the first dielectric layer and the strip conductor, a first patch conductor disposed on a top surface of the second dielectric layer so as to cover a position of the end part, a third dielectric layer laminated on the second dielectric layer and the first patch conductor, a second patch conductor disposed on a top surface of the third dielectric layer so that at least part of the second patch conductor covers a position in which the first patch conductor is formed, and being electrically independent, a fourth dielectric layer laminated on the third dielectric layer and the second patch conductor, a third patch conductor disposed on a top surface of the fourth dielectric layer so that at least part of the third patch conductor covers a position in which the second patch conductor is formed, and being electrically independent, a penetration conductor formed to penetrate the second dielectric layer, and to connect the end part and the first patch conductor. At least one auxiliary patch conductor is disposed on the top surface of the fourth dielectric layer on each side of the third patch conductor in a direction perpendicular to an extending direction of the strip conductor so as not to cover a position in which the third patch conductor is formed, and the auxiliary patch conductor is electrically independent of the third patch conductor.

According to an antenna board of the present invention, the center of the second patch conductor is disposed to be deviated in the extending direction of the strip conductor with respect to the center of the first patch conductor. Therefore, by the first and second patch conductors disposed in this manner, the complex resonance occurs satisfactorily, and consequently, it is possible to transmit and receive a satisfactory signal in a wide frequency band such as 57 to 66 GHz.

According to another antenna board of the present invention, at least one auxiliary patch conductor is disposed on each side of the second patch conductor in the direction perpendicular to the extending direction of the strip conductor, the second patch conductor disposed so that at least part of the second patch conductor covers the formation position of the first patch conductor, so as not to cover the position where the second patch conductor is formed. Therefore, by the first and second patch conductors and the auxiliary patch conductor disposed in this manner, the complex resonance occurs satisfactorily, and it is possible to transmit and receive a satisfactory signal in a wide frequency band such as 57 to 66 GHz.

According to still another antenna board of the present invention, at least one auxiliary patch conductor is disposed on each side of the third patch conductor in the direction perpendicular to the extending direction of the strip conductor, the third patch conductor disposed so that at least part of the third patch conductor covers the formation positions of the first patch conductor and the second patch conductor, so as not to cover the position where the third patch conductor is formed. Therefore, by the first to third patch conductors and the auxiliary patch conductor disposed in this manner, the complex resonance occurs satisfactorily, and it is possible to transmit and receive a satisfactory signal in a wide frequency band such as 57 to 66 GHz.

### BRIEF DESCRIPTION OF THE DRAWINGS

FIGS. 1A and 1B are a cross-sectional view and a top view, respectively, showing an antenna board according to a first preferred embodiment of the present invention;

FIG. 2 is an exploded perspective view of the antenna board shown in FIGS. 1A and 1B;

FIG. 3 is a graph showing a result of a simulation of return losses of a signal by using an analysis model by the antenna board of the present invention shown in FIGS. 1A and 1B and an analysis model by a conventional antenna board shown in FIGS. 11A and 11B;

FIGS. 4A and 4B are a cross-sectional view and a top view, respectively, showing an antenna board according to a second preferred embodiment of the present invention;

FIGS. 5A and 5B are a cross-sectional view and a top view, respectively, showing an antenna board according to a third preferred embodiment of the present invention;

FIGS. 6A and 6B are a cross-sectional view and a top view, respectively, showing an antenna board according to a fourth preferred embodiment of the present invention;

FIG. 7 is an exploded perspective view of the antenna board shown in FIGS. 6A and 6B;

FIG. 8 is a graph showing a result of a simulation of return losses of a signal by using an analysis model by the antenna board of the present invention shown in FIGS. 6A and 6B and an analysis model by a conventional antenna board shown in FIGS. 11A and 11B;

FIGS. 9A and 9B are a cross-sectional view and a top view, respectively, showing an antenna board according to a fifth preferred embodiment of the present invention;

FIG. 10 is a top view showing a change example according to a third preferred embodiment of the present invention shown in FIGS. 5A and 5B.

FIGS. 11A and 11B are a cross-sectional view and a top view, respectively, showing a conventional antenna board; and

FIG. 12 is an exploded perspective view of the antenna board shown in FIGS. 11A and 11B.

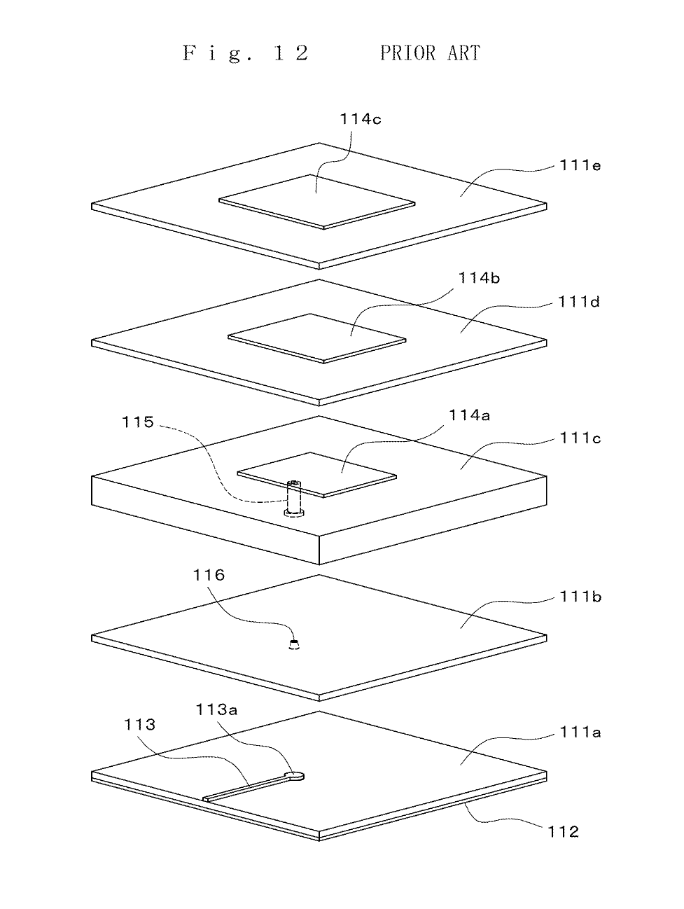

### DESCRIPTION OF THE PREFERRED EMBODIMENTS

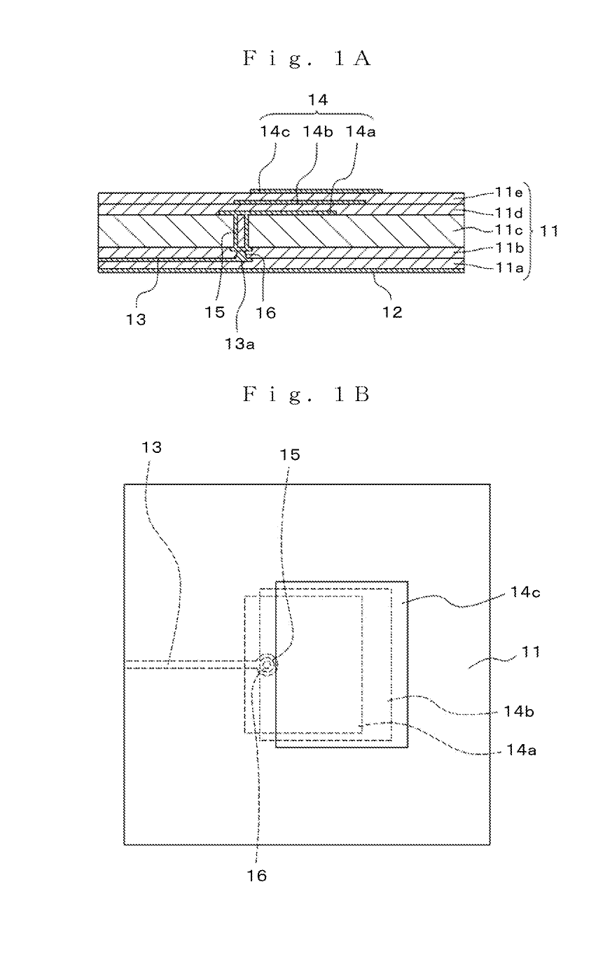

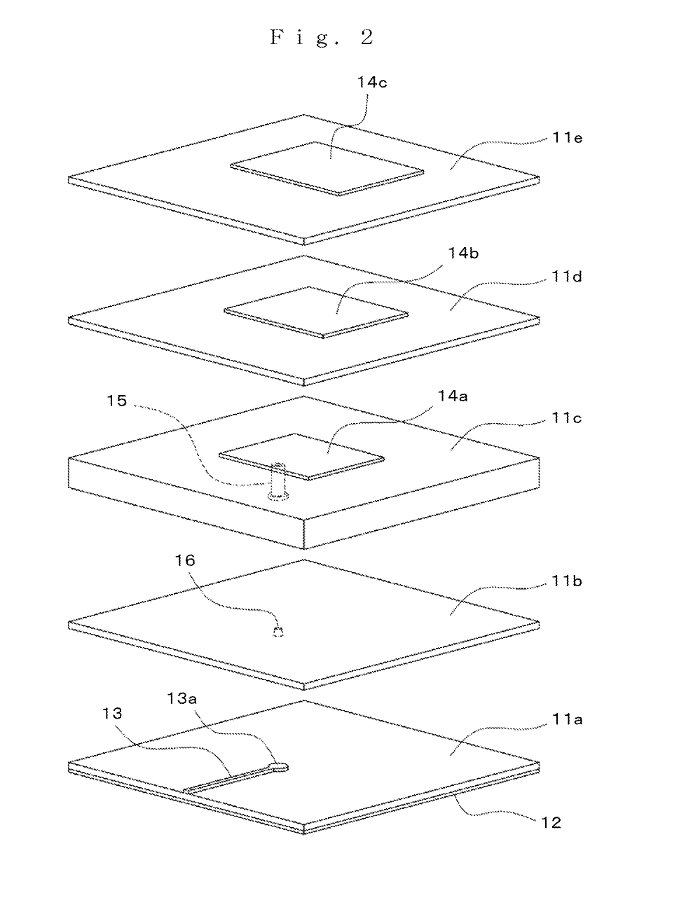

Next, a first preferred embodiment of an antenna board according to the present invention will be explained based on FIGS. 1A, 1B and 2. This antenna board includes a dielectric board 11 in which a plurality of dielectric layers 11a to 11e are laminated, a ground conductor layer 12 for shielding, a strip conductor 13 for inputting and outputting high-frequency signals, and a patch conductor 14 for transmitting and receiving electromagnetic waves as indicated by a cross-sectional view and top view shown in FIGS. 1A and 1B, respectively, and an exploded perspective view shown in FIG. 2.

The dielectric layers 11a to 11e include, for example, a dielectric material of a resin having the glass cloth impregnated with a thermosetting resin such as an epoxy resin, a bismaleimide triazine resin, and an allyl modified polyphenylene ether resin. The thickness of each of the dielectric layers 11a to 11e is about 30 to 100 μm. The dielectric constant of the dielectric layers 11a to 11e is about 3 to 5. The dielectric layers 11a to 11e include a first dielectric layer 11a, an intermediate dielectric layer 11b, a second dielectric layer 11c, a third dielectric layer 11d, and a fourth dielectric layer 11e, respectively.

The ground conductor 12 is deposited on the entire bottom surface of the dielectric layer 11a of the bottom layer. The ground conductor 12 functions as a shielding. The thickness of the ground conductor 12 is about 5 to 20 μm. The ground conductor 12 includes, for example, copper.

The strip conductor 13 is opposed to the ground conductor 12 across the first dielectric layer 11a, and is disposed between the first dielectric layer 11a and the intermediate dielectric layer 11b. The strip conductor 13 is a narrow strip-shaped conductor including an end part 13a in the central part of the dielectric board 11, and extends in one direction (hereinafter referred to as “extending direction”) to the end part 13a in the inner part of the dielectric board 11. The strip conductor 13 functions as a transmission line for inputting and outputting a high-frequency signal in the antenna board of the present invention, and a high-frequency signal is transmitted to the strip conductor 13. The width of the strip conductor 13 is about 50 to 350 μm. The thickness of the strip conductor 13 is about 5 to 20 μm. The strip conductor 13 includes, for example, copper.

The patch conductor 14 includes a first patch conductor 14a, a second patch conductor 14b, and a third patch conductor 14c. These patch conductors 14a to 14c are electrically independent of each other. The patch conductors 14a to 14c include quadrangle shapes having the sides parallel to the extending direction of the strip conductor 13 (hereinafter referred to as “longitudinal side”) and the sides parallel in a direction perpendicular to the extending direction (hereinafter referred to as “lateral side”). The length of each side of the patch conductors 14a to 14c is about 0.5 to 5 mm. The thickness of each of the patch conductors 14a to 14c is about 5 to 20 μm. Each of the patch conductors 14a to 14c includes, for example, copper.

The first patch conductor 14a is disposed between the second dielectric layer 11c and the third dielectric layer 11d so as to cover the position of the end part 13a of the strip conductor 13. Therefore, between the first patch conductor 14a and the strip conductor 13, two layers of the dielectric layers 11b and 11c are interposed.

The first patch conductor 14a is connected to the end part 13a of the strip conductor 13 via a penetration conductor 15 penetrating the second dielectric layer 11c and a penetration conductor 16 penetrating the intermediate dielectric layer 11b. The penetration conductor 15 has a cylindrical shape with a diameter of about 50 to 200 μm and a thickness of about 5 to 20 μm. The penetration conductor 16 has a cylindrical shape or a truncated cone shape with a diameter of about 30 to 100 μm. Each of the penetration conductors 15 and 16 includes, for example, copper. The first patch conductor 14a radiates an electromagnetic wave to the outside by receiving the supply of a high-frequency signal from the strip conductor 13. Alternatively, the first patch conductor 14a leads the strip conductor 13 to generate a high-frequency signal by receiving an electromagnetic wave from the outside.

The second patch conductor 14b is disposed between the third dielectric layer 11d and the fourth dielectric layer 11e so that at least a portion of the second patch conductor 14b covers the position where the first patch conductor 14a is formed. Thereby, the second patch conductor 14b is capacitively coupled with the first patch conductor 14a across the third dielectric layer 11d. By receiving an electromagnetic wave from the first patch conductor 14a, the second patch conductor 14b radiates to the outside an electromagnetic wave corresponding to the received electromagnetic wave. Alternatively, by receiving an electromagnetic wave from the outside, the second patch conductor 14b supplies the first patch conductor 14a with an electromagnetic wave corresponding to the received electromagnetic wave. Each side of the second patch conductor 14b is preferred to be larger than the corresponding side of the first patch conductor 14a by about 0.05 to 0.5 mm.

The third patch conductor 14c is disposed on a top surface of the fourth dielectric layer 11e of the uppermost layer so that at least a portion of the third patch conductor 14c covers the position where the second patch conductor 14b is formed. Thereby, the third patch conductor 14c is capacitively coupled with the second patch conductor 14b across the fourth dielectric layer 11e. By receiving an electromagnetic wave from the second patch conductor 14b, the third patch conductor 14c radiates to the outside an electromagnetic wave corresponding to the received electromagnetic wave. Alternatively, by receiving an electromagnetic wave from the outside, the third patch conductor 14c supplies the second patch conductor 14b with an electromagnetic wave corresponding to the received electromagnetic wave. Each side of the third patch conductor 14c is preferred to be larger than the corresponding side of the second patch conductor 14b by about 0 to 0.5 μm.

Furthermore, in this preferred embodiment, the center of the second patch conductor 14b is disposed to be deviated in the extending direction of the strip conductor 13 with respect to the center of the first patch conductor 14a, and the center of the third patch conductor 14c is disposed to be deviated in the extending direction of the strip conductor 13 with respect to the center of the second patch conductor 14b. The deviation of the second patch conductor 14b has the extent so that the second patch conductor 14b covers the area of 80% or more of the position where the first patch conductor 14a is formed. The deviation of the third patch conductor 14c has the extent so that the third patch conductor 14c covers the area of 80% or more of the position where the second patch conductor 14b is formed. The term “the center of a patch conductor” means the intersection of the two diagonals when the patch conductor has a quadrangle shape.

Thus, the center of the second patch conductor 14b is disposed to be deviated in the extending direction of the strip conductor 13 with respect to the center of the first patch conductor 14a, and the center of the third patch conductor 14c is disposed to be deviated in the extending direction of the strip conductor 13 with respect to the center of the second patch conductor 14b. Thus, for example, when an electromagnetic wave corresponding to the high-frequency signal is radiated via the patch conductors 14a to 14c, the electromagnetic wave is radiated so as to sequentially spread along the outer peripheral edges from the patch conductor 14a on the lower side to the patch conductors 14b and 14c on the upper side, and the complex resonance occurs by the deviation and the electromagnetic wave is radiated, and therefore, the frequency band of the high-frequency signal radiated via the patch conductors 14a to 14c becomes wide. In particular, the second patch conductor 14b is disposed so that the second patch conductor 14b covers the area of 80% or more of the position where the first patch conductor 14a is formed, and the third patch conductor 14c is disposed so that the third patch conductor 14c covers the area of 80% or more of the position where the second patch conductor 14b is formed, and thereby, the frequency band of the high-frequency signal becomes wider.

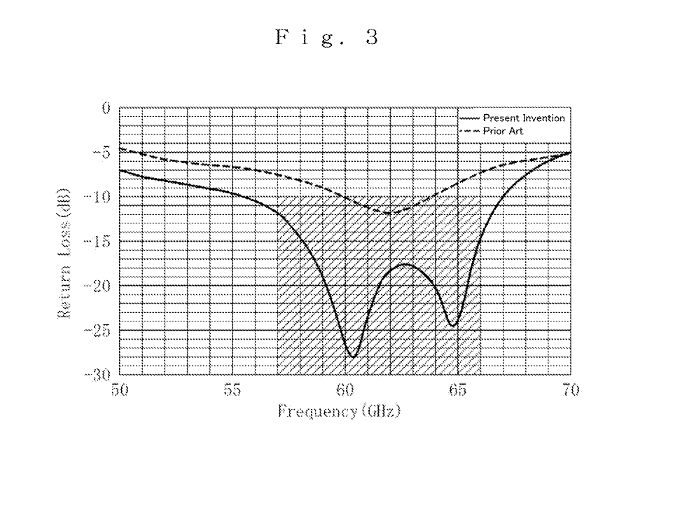

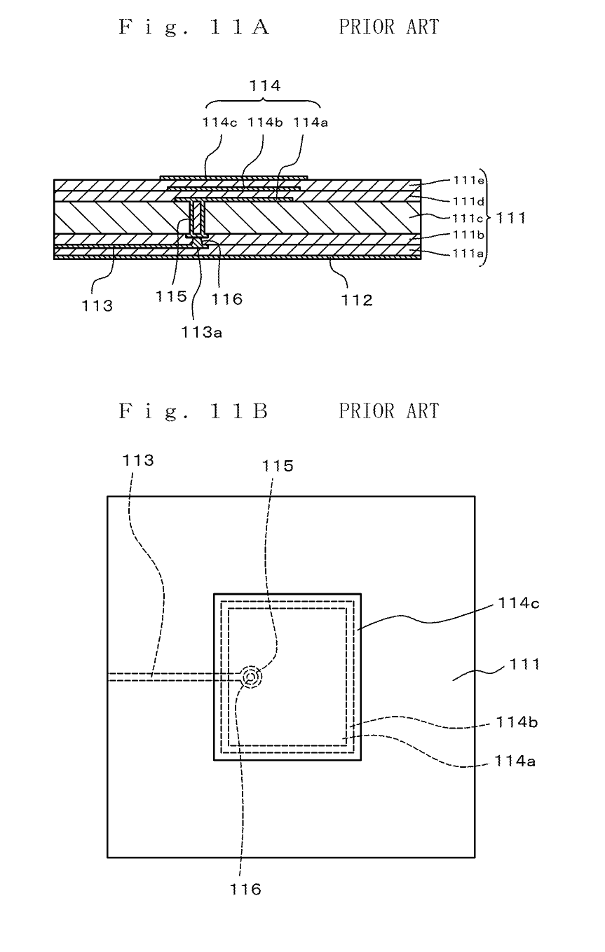

Here, in analysis models where the antenna board of the present invention shown in FIGS. 1A and 1B and the conventional antenna board shown in FIGS. 11A and 11B were modeled, the return losses were simulated by an electromagnetic field simulator when a high-frequency signal was inputted into a strip conductor. The results are shown in FIG. 3. In FIG. 3, the graph indicated by the solid line is the return loss of the analysis model by the antenna board of the present invention, and the graph shown by the broken line is the return loss of the analysis model by the conventional antenna board. In FIG. 3, the inside of the hatched region shows the required property area. In the frequency band of 57 GHz to 66 GHz, the return loss of −10 dB or less is required. As is apparent in FIG. 3, in the analysis model by the conventional antenna board, the band of the return loss of −10 dB or less which is required by an antenna board is a narrow band of about 60 to 64 GHz. In contrast to this, in the analysis model by the antenna board of the present invention, the band of the return loss of −10 dB or less is found to be a broad band of about 55.5 to 67 GHz.

The simulation conditions were as follows. In the analysis model by the antenna board of the present invention, each of the dielectric layers 11a to 11e had the dielectric constant of 3.35. Each of the dielectric layers 11a, 11b, 11d and 11e had the thickness of 50 μm, and the dielectric layer 11c had the thickness of 100 μm. The strip conductor 13, the ground conductor layer 12 and the patch conductors 14a to 14c were formed by copper, and each of them had the thickness of 18 μm. The strip conductor 13 had the width of 85 μm and the length of 3 mm, and was disposed so as to extend in one direction from the outer peripheral edge to the central part of the dielectric board 11 between the dielectric layers 11a and 11b, and so that the end part 13a was positioned in the central part of the dielectric board 11. In the end part 13a of the strip conductor 13, a circular land pattern of 180 μm in diameter was disposed.

As for the first patch conductor 14a, the longitudinal side parallel in the extending direction of the strip conductor 13 had the length of 1 mm, and that the lateral side perpendicular to this had the length of 1.1 mm. The first patch conductor 14a and the land pattern disposed on the end part 13a of the strip conductor 13 were connected by the penetration conductors 15 and 16 having cylindrical shapes of 90 μm in diameter. The connection position of the penetration conductor 15 was where the center of the penetration conductor 15 came to the position which was the center between the two longitudinal sides of the first patch conductor 14a, and which was 150 μm from the lateral side on the side to which the strip conductor 13 extended. The penetration conductors 15 and 16 were formed by copper.

As for the second patch conductor 14b, the longitudinal side parallel in the extending direction of the strip conductor 13 had the length of 1.1 mm, and the lateral side perpendicular to this had the length of 1.4 mm. The second patch conductor 14b was disposed at a position where the position of its center was deviated from the center of the first patch conductor 14a in the extending direction of the strip conductor 13 so as to cover the area of 90% of the position where the first patch conductor 14a was formed.

As for the third patch conductor 14c, the longitudinal side parallel in the extending direction of the strip conductor 13 had the length of 1.1 mm, and that the lateral side perpendicular to this had the length of 1.6 mm. The third patch conductor 14c was disposed at a position where the position of its center was deviated from the center of the second patch conductor 14b in the extending direction of the strip conductor 13 so as to cover the area of 90% of the position where the second patch conductor 14b was formed.

In addition, as for the analysis model by the conventional antenna board, a model was used which was entirely identical with the analysis model by the antenna board of the present invention described above except that the center of each of the patch conductors 14a to 14c was not deviated.

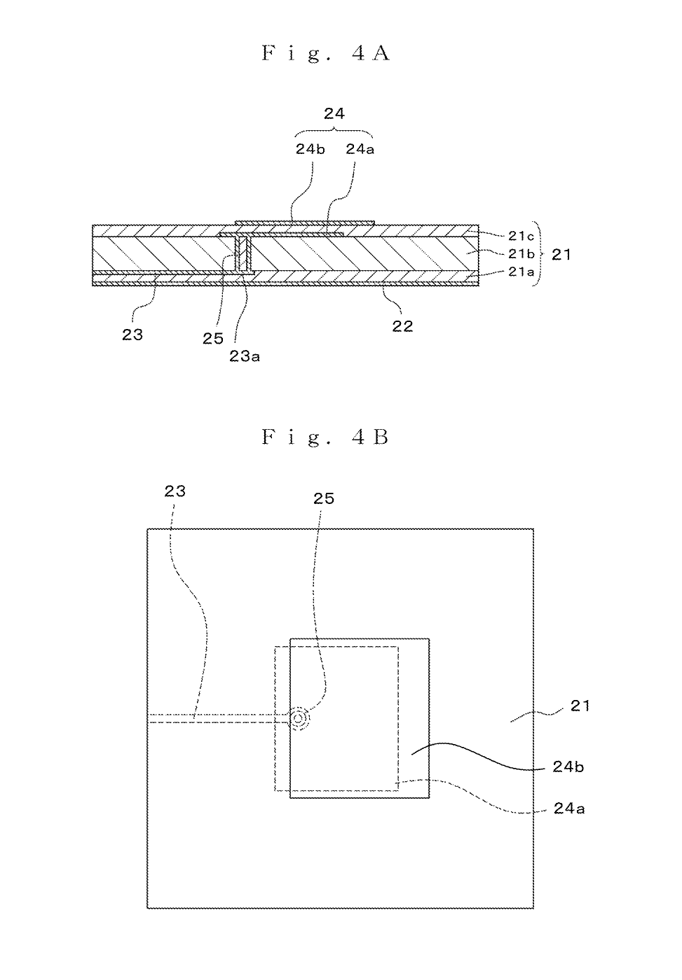

Next, a second preferred embodiment according to the present invention will be explained. In the first preferred embodiment, as described above, the dielectric board 11 includes the five layers of the dielectric layers 11a to 11e, and the patch conductor 14 includes the three layers of the first patch conductor 14a, the second patch conductor 14b, and the third patch conductor 14c. On the other hand, in the second preferred embodiment, as shown in FIGS. 4A and 4B, a dielectric board 21 includes the three layers of a first, a second, and a third dielectric layers 21a to 21c, and a patch conductor 24 includes the two layers of a first patch conductor 24a, and a second patch conductor 24b.

As for the first patch conductor 24a and the second patch conductor 24b, the center of the second patch conductor 24b is disposed to be deviated in the extending direction of a strip conductor 23 with respect to the center of the first patch conductor 24a. The second patch conductor 24b is preferred to be disposed so as to cover the area of 80% or more of the position where the first patch conductor 24a is formed. Even in this case, when an electromagnetic wave corresponding to a high-frequency signal is radiated via the patch conductors 24a and 24b, the electromagnetic wave is radiated so as to sequentially spread along the outer peripheral edges from the patch conductor 24a on the lower side to the patch conductor 24b on the upper side and the patch conductors 24a and 24b are disposed to be deviated to each other, and thereby, the complex resonance occurs, and the electromagnetic wave is radiated. Therefore, the frequency band of the high-frequency signal radiated via the first and second patch conductors 24a and 24b can be made wide enough to cover the range of 57 to 66 GHz.

The rest is the same as that of the antenna board according to the first preferred embodiment, and therefore, a detailed description will be omitted.

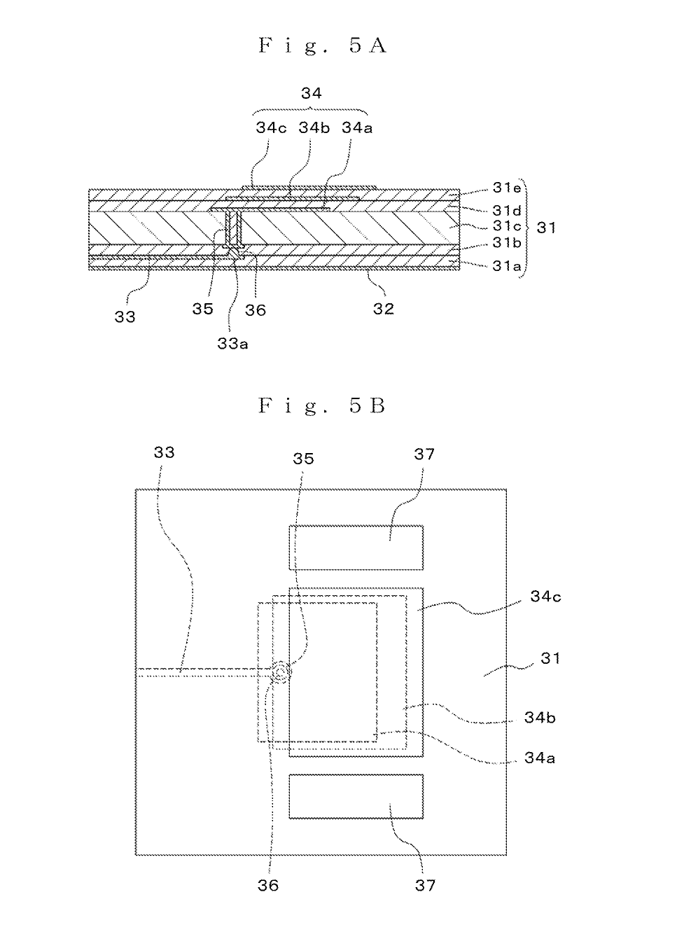

Next, a third preferred embodiment according to the present invention will be explained. An antenna board according to the third preferred embodiment is the antenna board according to the above mentioned first preferred embodiment being further provided with auxiliary patch conductors. Specifically, as for the antenna board according to the third preferred embodiment, as shown in FIGS. 5A and 5B, auxiliary patch conductors 37 which are electrically independent are disposed on the top surface of the fourth dielectric layer 31e of the uppermost layer, on both sides of the third patch conductor 34c in the direction perpendicular to the extending direction of the strip conductor 33, so as not to cover the position where the third patch conductor 34c is formed. In this case, via the interval between the third patch conductor 34c and the auxiliary patch conductors 37, and via edge parts of the auxiliary patch conductors 37, the complex resonance occurs further. Therefore, the frequency band of the high-frequency signal radiated via the first to third patch conductors 34a to 34c and the auxiliary patch conductors 37 can be made wider. The rest is the same as that of the antenna board according to the first preferred embodiment, and therefore, a detailed description will be omitted.

The auxiliary patch conductors 37 are preferred to be disposed at an interval of about 0.1 to 1 mm from the third patch conductor 34c. The auxiliary patch conductors 37 include quadrangle shapes, in which the length of each side is about 0.1 to 5 mm, with longitudinal sides parallel to the longitudinal sides of the third patch conductor 34c and lateral sides parallel to the lateral sides of the third patch conductor 34c. The auxiliary patch conductors 37 also include, for example, copper in the same manner as the patch conductor 34.

The longitudinal side of the auxiliary patch conductors 37 is preferred to have the same length as the longitudinal side of the third patch conductor 34c, and the lateral side of the auxiliary patch conductors 37 is preferred to be shorter than the lateral side of the third patch conductor 34c. It is preferred that the longitudinal side of the second patch conductor 34b is longer than the longitudinal side of the first patch conductor 34a, and that, furthermore, the longitudinal side of the third patch conductor 34c has the length of the longitudinal side of the second patch conductor 34b or larger, and that the length of the lateral side of the third patch conductor 34c is larger than the length of the lateral side of the second patch conductor 34b, and that the length of the lateral side of the second patch conductor 34b is larger than the length of the lateral side of the first patch conductor 34a. Thus, the frequency band of the high-frequency signal radiated via the first to third patch conductors 34a to 34c and the auxiliary patch conductors 37 can be further made wider.

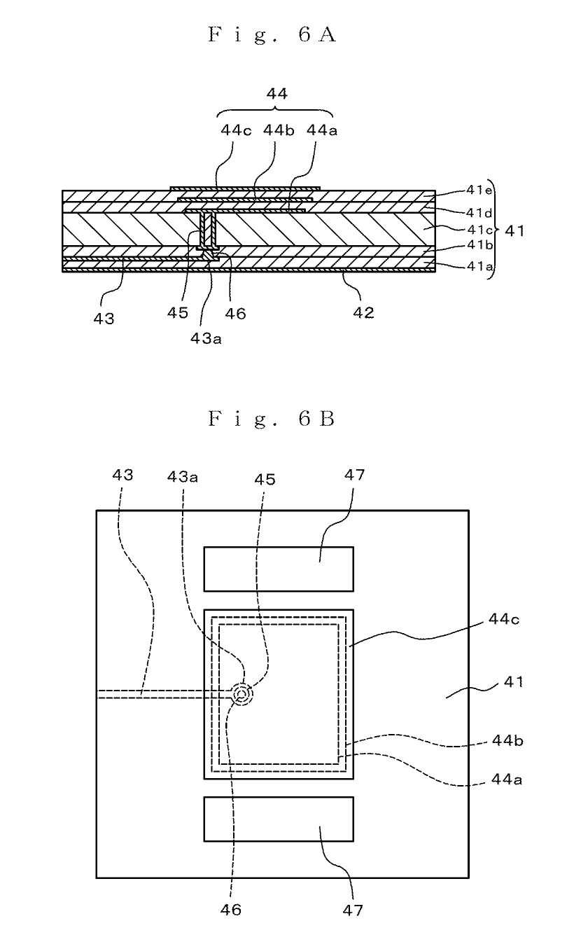

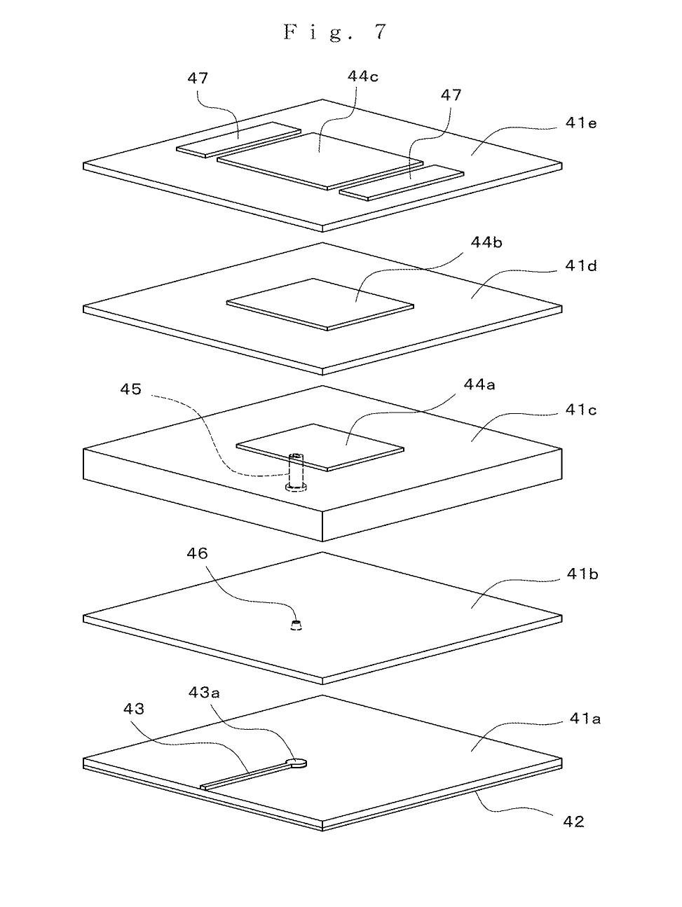

Next, a fourth preferred embodiment according to the present invention will be explained. An antenna board according to the fourth preferred embodiment includes, as shown in FIGS. 6A, 6B, and 7, a dielectric board 41 in which a first dielectric layer 41a, an intermediate dielectric layer 41b, a second dielectric layer 41c, a third dielectric layer 41d, and a fourth dielectric layer 41e are laminated, a ground conductor layer 42 for shielding, a strip conductor 43 for inputting and outputting high-frequency signals, a patch conductor 44 for transmitting and receiving electromagnetic waves, and auxiliary patch conductors 47.

In the antenna board according to the fourth preferred embodiment, unlike in the first preferred embodiment, the first to third patch conductors 44a to 44c are disposed without deviating their respective centers, and furthermore, the auxiliary patch conductors 47 are disposed on the top surface of the fourth dielectric layer 41e of the uppermost layer. The two auxiliary patch conductors 47 are disposed on both sides of the third patch conductor 44c in the direction perpendicular to the extending direction of the strip conductor 43. The rest is the same as those of the first and third preferred embodiments, and therefore, a detailed description will be omitted.

Thus, in the fourth preferred embodiment, the auxiliary patch conductors 47 are disposed on the top surface of the fourth dielectric layer 41e, on both sides of the third patch conductor 44c in the direction perpendicular to the extending direction of the strip conductor 43, so as not to cover the third patch conductor 44c. Thereby, for example, when an electromagnetic wave corresponding to the high-frequency signal is radiated via the patch conductors 44a to 44c, the electromagnetic wave is radiated so as to sequentially spread along the outer peripheral edges from the patch conductor 44a on the lower side to the patch conductors 44b and 44c on the upper side, and the complex resonance occurs via the interval between the third patch conductor 44c and the auxiliary patch conductors 47 and via edge parts of the auxiliary patch conductors 47, and the electromagnetic wave is radiated. Therefore, the frequency band of the high-frequency signal radiated via the first to third patch conductors 44a to 44c and the auxiliary patch conductors 47 can be made wide.

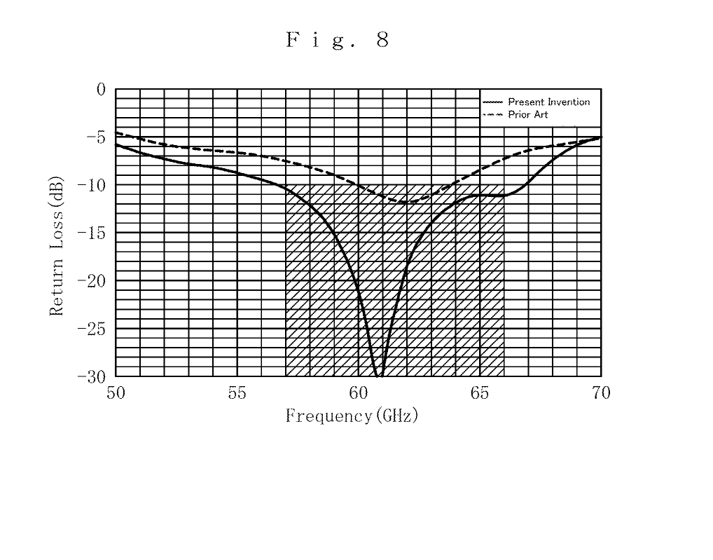

Here, in analysis models where the antenna board of the present invention shown in FIGS. 6A and 6B and the conventional antenna board shown in FIGS. 11A and 11B were modeled, the return losses were simulated by an electromagnetic field simulator when a high-frequency signal was inputted into a strip conductor. The results are shown in FIG. 8. In FIG. 8, the graph indicated by the solid line is the return loss of the analysis model by the antenna board of the present invention, and the graph shown by the broken line is the return loss of the analysis model by the conventional antenna board. In FIG. 8, the inside of the hatched region shows the required property area. In the frequency band of 57 GHz to 66 GHz, the return loss of −10 dB or less is required.

As is apparent in FIG. 8, in the analysis model by the conventional antenna board, the band of the return loss of −10 dB or less which is required by an antenna board is a narrow band of about 60 to 64 GHz, and in contrast to this, in the analysis model by the antenna board of the present invention, the band of the return loss of −10 dB or less is found to be a broad band of about 56.5 to 67 GHz.

The simulation conditions were as follows. In the analysis model by the antenna board of the present invention, each of the dielectric layers 41a to 41e in FIGS. 6A and 6B had the dielectric constant of 3.35. Each of the dielectric layers 41a, 41b, 41d and 41e had the thickness of 50 μm, and the dielectric layer 41c had the thickness of 100 μm. The strip conductor 43, the ground conductor layer 42, the patch conductors 44a to 44c, and the auxiliary patch conductors 47 were formed by copper, and each of them had the thickness of 18 μm. The strip conductor 43 had the width of 85 μm and the length of 3 mm, and was disposed so as to extend in one direction from the outer peripheral edge to the central part of the dielectric board 41 between the dielectric layers 41a and 41b, and so that the end part 43a was positioned in the central part of the dielectric board 41. In the end part 43a of the strip conductor 43, a circular land pattern of 180 μm in diameter was disposed.

As for the first patch conductor 44a, the longitudinal side parallel in the extending direction of the strip conductor 43 had the length of 1 mm, and that the lateral side perpendicular to this had the length of 1.1 mm. The first patch conductor 44a and the land pattern disposed on the end part 43a of the strip conductor 43 were connected by the penetration conductors 45 and 46 having cylindrical shapes of 90 μm in diameter. The connection position of the penetration conductor 45 was where the center of the penetration conductor 45 came to the position which was the center between the two longitudinal sides of the first patch conductor 44a, and which was 150 μm from the lateral side on the side to which the strip conductor 43 extended. The penetration conductors 45 and 46 were formed by copper.

As for the second patch conductor 44b, the longitudinal side parallel in the extending direction of the strip conductor 43 had the length of 1.1 mm, and the lateral side perpendicular to this had the length of 1.4 mm. The second patch conductor 44b was disposed so that the position of its center overlapped with the position of the center of the first patch conductor 44a.

As for the third patch conductor 44c, the longitudinal side parallel in the extending direction of the strip conductor 43 had the length of 1.1 mm, and the lateral side perpendicular to this had the length of 1.6 mm. The third patch conductor 44c was disposed so that the position of its center overlapped with the positions of the centers of the first and second patch conductors 44a and 44b.

As for the auxiliary patch conductors 47, the longitudinal side parallel in the extending direction of the strip conductor 43 had the length of 1.1 mm, and the lateral side perpendicular to this had the length of 0.5 mm. The auxiliary patch conductors 47 were disposed one by one on each side in the long side direction of the third patch conductor 44c so that the longitudinal side was to be aligned immediately beside the longitudinal side of the third patch conductor 44c. The distance between the third patch conductor 44c and the auxiliary patch conductors 47 was 0.3 mm.

In addition, as for the analysis model by the conventional antenna board, a model was used which was entirely identical with the analysis model by the antenna board shown in FIGS. 6A and 6B except that the auxiliary patch conductors 47 were not disposed.

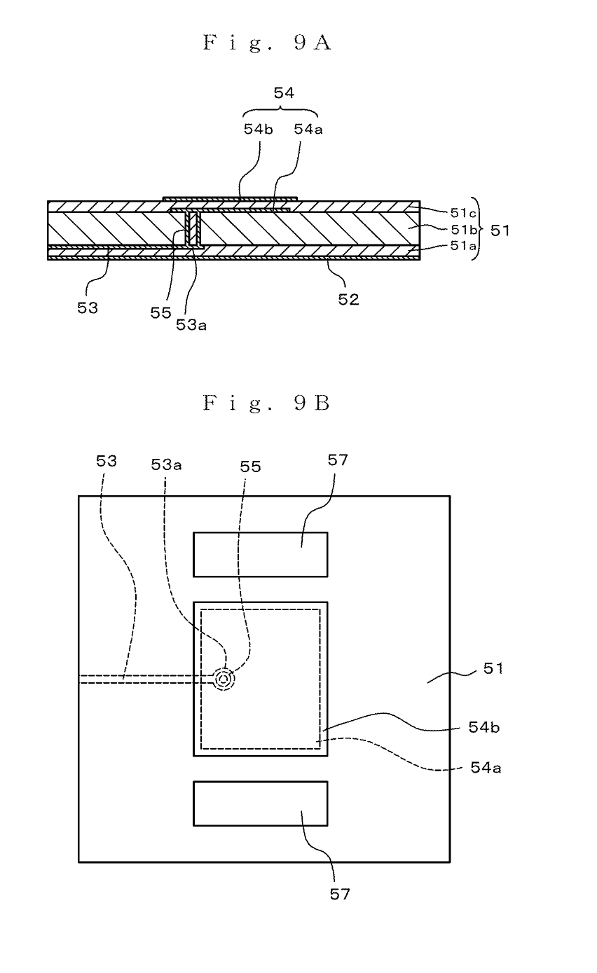

Next, a fifth preferred embodiment according to the present invention will be explained. In the fourth preferred embodiment, as described above, the dielectric board 41 includes the five layers of the dielectric layers 41a to 41e, and the patch conductor 44 includes the three layers of the first patch conductor 44a, the second patch conductor 44b, and the third patch conductor 44c. On the other hand, in the fifth preferred embodiment, as shown in FIGS. 9A and 9B, a dielectric board 51 includes the three layers of a first, a second, and a third dielectric layers 51a to 51c, and a patch conductor 54 includes the two layers of a first patch conductor 54a, and a second patch conductor 54b. Auxiliary patch conductors 57 which are electrically independent are disposed on the top surface of the dielectric layer 51c of the uppermost layer, on both sides of the second patch conductor 54b in the direction perpendicular to the extending direction of the strip conductor 53, so as not to cover the second patch conductor 54b.

Even in this case, when an electromagnetic wave corresponding to the high-frequency signal is radiated via the patch conductors 54a and 54b, the electromagnetic wave is radiated so as to sequentially spread along the outer peripheral edges from the first patch conductor 54a on the lower side to the second patch conductor 54b on the upper side, and the complex resonance occurs via the interval between the second patch conductor 54b and the auxiliary patch conductors 57 and via edge parts of the auxiliary patch conductors 57, and the electromagnetic wave is radiated. Therefore, the frequency band of the high-frequency signal radiated via the first and second patch conductors 54a and 54b and the auxiliary patch conductors 57 can be made wide enough to cover the range of 57 to 66 GHz. The rest is the same as those of the antenna boards according to the above-mentioned preferred embodiments, and therefore, a detailed description will be omitted.

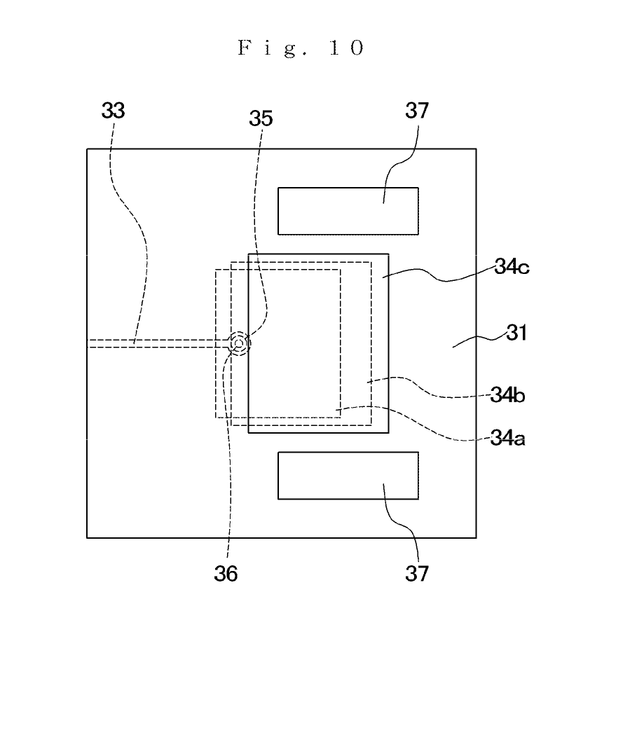

While preferred embodiments of the present invention have been described, it is to be understood that changes and variations may be made without departing from the spirit or scope of the following claims. For example, the antenna board shown in FIGS. 4A and 4B may be provided with the auxiliary patch conductors. Additionally, at least one of the auxiliary patch conductor may be disposed to be deviated in the extending direction of the strip conductor with respect to the patch conductor of the uppermost layer. FIG. 10 shows the situation when this change is applied to the antenna board shown in FIGS. 5A and 5B. This change enables a frequency band to be wider. This change is applicable to all preferred embodiments having auxiliary patch conductors like the antenna board shown in, such as, FIGS. 6A and 6B, and 9A and 9B. Furthermore, in the above-described preferred embodiments, the patch conductors and the auxiliary patch conductors have quadrangle shapes, but may have other shapes such as circular shape, and polygonal shape.

What is claimed is:

1. An antenna board comprising:
a first dielectric layer;
a strip conductor that is disposed on a top surface of the first dielectric layer, extends in one direction from an outer peripheral part of the first dielectric layer, and includes an end part;
a ground conductor layer disposed on a bottom surface side of the first dielectric layer;
a second dielectric layer laminated on a top surface side of the first dielectric layer and the strip conductor;
a first patch conductor disposed on a top surface of the second dielectric layer so as to cover a position of the end part;
a third dielectric layer laminated on the second dielectric layer and the first patch conductor;
a second patch conductor disposed on a top surface of the third dielectric layer; and
a penetration conductor formed to penetrate the second dielectric layer, and to connect the end part and the first patch conductor,
wherein the first patch conductor and the second patch conductor have following relations (1) to (3):
(1) the first patch conductor and the second patch conductor are electrically independent,
(2) at least part of the second patch conductor covers a position in which the first patch conductor is formed, and
(3) a center of the second patch conductor is deviated in an extending direction of the strip conductor with respect to a center of the first patch conductor.

2. The antenna board according to claim 1, wherein the second patch conductor is disposed to cover an area of 80% or more of the position in which the first patch conductor is formed.

3. The antenna board according to claim 1, further comprising:
a fourth dielectric layer laminated on the third dielectric layer and the second patch conductor; and
a third patch conductor disposed on a top surface of the fourth dielectric layer so that at least part of the third patch conductor covers a position in which the second patch conductor is formed, the third patch conductor being electrically independent of the second patch conductor,
wherein a center of the third patch conductor is deviated in the extending direction of the strip conductor with respect to the center of the second patch conductor.

4. The antenna board according to claim 3, wherein the third patch conductor is disposed to cover an area of 80% or more of the position in which the second patch conductor is formed.

5. The antenna board according to claim 1, wherein at least one auxiliary patch conductor is disposed on the top surface of the third dielectric layer on each side of the second patch conductor in a direction perpendicular to the extending direction of the strip conductor so as not to cover a position in which the second patch conductor is formed, and the auxiliary patch conductor is electrically independent of the second patch conductor.

6. The antenna board according to claim 5, wherein at least one of the auxiliary patch conductor is disposed to be deviated in the extending direction of the strip conductor with the second patch conductor.

7. The antenna board according to claim 3, wherein at least one auxiliary patch conductor is disposed on the top surface of the fourth dielectric layer on each side of the third patch conductor in a direction perpendicular to the extending direction of the strip conductor so as not to cover a position in which the third patch conductor is formed, and the auxiliary patch conductor is electrically independent of the third patch conductor.

8. The antenna board according to claim 7, wherein at least one of the auxiliary patch conductor is disposed to be deviated in the extending direction of the strip conductor with the third patch conductor.

9. An antenna board comprising:
a first dielectric layer;
a strip conductor that is disposed on a top surface of the first dielectric layer, extends in one direction from an outer peripheral part of the first dielectric layer, and includes an end part;
a ground conductor layer disposed on a bottom surface side of the first dielectric layer;
a second dielectric layer laminated on a top surface side of the first dielectric layer and the strip conductor;
a first patch conductor disposed on a top surface of the second dielectric layer so as to cover a position of the end part;
a third dielectric layer laminated on the second dielectric layer and the first patch conductor;
a second patch conductor disposed on a top surface of the third dielectric layer so that at least part of the second patch conductor covers a position in which the first patch conductor is formed, and being electrically independent; and
a penetration conductor formed to penetrate the second dielectric layer, and to connect the end part and the first patch conductor,
wherein at least one auxiliary patch conductor is disposed on the top surface of the third dielectric layer on each side of the second patch conductor in a direction perpendicular to an extending direction of the strip conductor so as not to cover a position in which the second patch conductor is formed, and the auxiliary patch conductor is electrically independent of the second patch conductor.

10. The antenna board according to claim 9, wherein at least one of the auxiliary patch conductor is disposed to be deviated in the extending direction of the strip conductor with the second patch conductor.

11. An antenna board comprising:
a first dielectric layer;
a strip conductor that is disposed on a top surface of the first dielectric layer, extends in one direction from an outer peripheral part of the first dielectric layer, and includes an end part;
a ground conductor layer disposed on a bottom surface side of the first dielectric layer;
a second dielectric layer laminated on a top surface side of the first dielectric layer and the strip conductor;
a first patch conductor disposed on a top surface of the second dielectric layer so as to cover a position of the end part;
a third dielectric layer laminated on the second dielectric layer and the first patch conductor;
a second patch conductor disposed on a top surface of the third dielectric layer so that at least part of the second patch conductor covers a position in which the first patch conductor is formed, and being electrically independent;
a fourth dielectric layer laminated on the third dielectric layer and the second patch conductor;
a third patch conductor disposed on a top surface of the fourth dielectric layer so that at least part of the third patch conductor covers a position in which the second patch conductor is formed, and being electrically independent;
a penetration conductor formed to penetrate the second dielectric layer, and to connect the end part and the first patch conductor,
wherein at least one auxiliary patch conductor is disposed on the top surface of the fourth dielectric layer on each side of the third patch conductor in a direction perpendicular to an extending direction of the strip conductor so as not to cover a position in which the third patch conductor is formed, and the auxiliary patch conductor is electrically independent of the third patch conductor.

12. The antenna board according to claim 11, wherein at least one of the auxiliary patch conductor is disposed to be deviated in the extending direction of the strip conductor with the third patch conductor.
